(19) United States
(12) Patent Application Publication
(10) Pub. No.: US 2011/0273352 A1
(43) Pub. Date: Nov. 10, 2011

(54) Antenna Structure

(76) Inventor: You-Cheng YOU, Jhongli City (TW)

(21) Appl. No.: 12/774,117

(22) Filed: May 5, 2010

(51) Int. Cl. H01Q 9/04; H01Q 19/10

(52) U.S. Cl. 343/834; 343/700 MS

(57) ABSTRACT

An antenna structure includes an antenna radiating portion, a grounding portion, a connecting portion and a reflecting element, and the antenna radiating portion includes a feed point, and the grounding portion is perpendicular to the antenna radiating portion, and the connecting portion is coupled to the antenna radiating portion and the reflecting portion, and the reflecting element is installed on another side of the grounding portion and corresponding to the antenna radiating portion, and the reflecting element includes first and second reflecting portions with an included angle between the first and second reflecting portions equal to 0˜65 degrees, and the antenna radiating portion and the reflecting element are formed integrally by bending a metal sheet to achieve effects of reducing interferences caused by external factors, providing the desired directivity, lowering the production cost, and reducing the manufacturing time.

### BACKGROUND OF THE INVENTION

1. Field of the Invention

The present invention generally relates to antenna structures, and more particularly to an improved antenna device having an antenna radiating portion and a reflecting portion manufactured on a single object to lower cost and reduce production time.

2. Description of the Related Art

As to a wireless communication product, an antenna used for transmitting and receiving electromagnetic signals is a necessary key component, and the electric properties of the antenna closely relates to the communication quality of the antenna, and the antenna tends to be used with increasingly smaller and thinner electronic devices to maximize its signal transmission effect in wireless communications. Manufacturers spare no effort to develop mini antennas to meet the requirements of electronic equipments. Therefore, a planar inverted F-antenna (PIFA) antenna is introduced, and the antennas of this type have the advantages of an excellent radiation pattern, a simple structure and an easy manufacturing process, and the length of the antenna is just one-quarter of the wavelength, so that the PIFA antennas can meet the mini-size and low-cost requirements of the market.

The conventional PIFA antennas have better directivity and gain, and a reflecting board is generally provided for reflecting electromagnetic waves emitted by the antenna and guiding the electromagnetic waves to travel in a fixed direction. However, conventional reflecting boards are manufactured and formed separately and installed with the antenna through an assembling structure, and thus the assembling structure or the assembling process incurs other external factors that may affect the directivity of the antenna device. Furthermore, too many assembling structures will occupy too much area of the reflecting board, so that the volume of the wireless communication product cannot be minimized, and the manufacturing cost is increased. Obviously, the conventional design is unable to satisfy the user requirements for a light, thin, short and small design of a wireless communication product, while maintaining an excellent communication performance.

### SUMMARY OF THE INVENTION

Therefore, it is a primary objective of the present invention to overcome the foregoing drawbacks of the prior art by providing an antenna device that manufactures an antenna radiating portion and a reflecting element on a single object to lower production cost and reduce manufacturing time.

To achieve the foregoing objective, the present invention provides an antenna structure comprising: an antenna radiating portion, a grounding portion, a connecting portion, and a reflecting element, and the antenna radiating portion includes a feed point, and the grounding portion and the antenna radiating portion are perpendicular to each other, and the connecting portion is coupled to the antenna radiating portion and the reflecting portion, and the reflecting element is installed on another side of the grounding portion and corresponding to the antenna radiating portion.

In the present invention, the antenna radiating portion and the reflecting element are integrally formed by bending a metal sheet to achieve the effects of reducing interferences caused by any other external factors, providing a desired directivity, lowering the production cost, and reducing the manufacturing time.

The reflecting element includes first and second reflecting portions, wherein an included angle between the first and second reflecting portions falls within a range of 0-65 degrees, such that the included angle between the first and second reflecting portions can be used for adjusting and controlling the antenna to obtain a good radiation pattern.

### BRIEF DESCRIPTION OF THE DRAWINGS

FIG. 1 is a perspective view of an antenna structure of the present invention;

FIG. 2 is a schematic view of an antenna structure of the present invention;

FIG. 3 is a cross-sectional view of an antenna structure of the present invention;

FIG. 4 is a radiation pattern chart of a first preferred embodiment of the present invention;

FIG. 5 is a radiation pattern chart of a second preferred embodiment of the present invention;

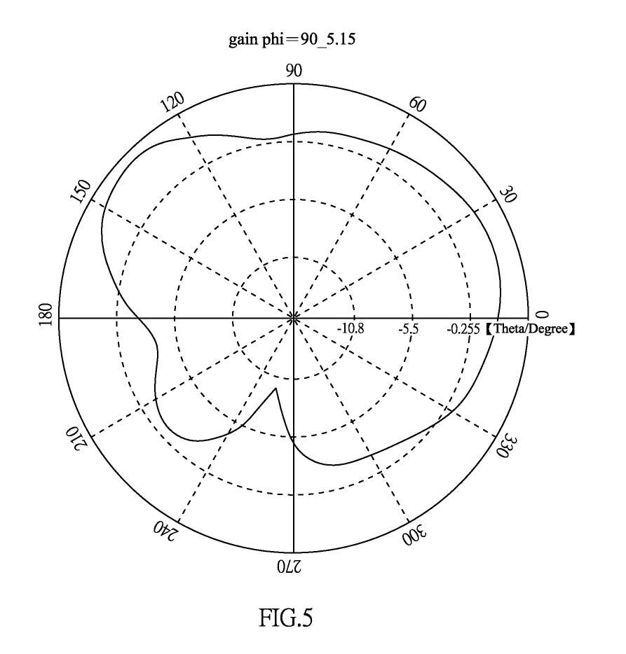

FIG. 6 is a schematic view of an antenna structure applied to a multi-input multi-output (MIMO) in accordance with the present invention; and

FIG. 7 is a schematic view of another antenna structure applied to a multi-input multi-output (MIMO) in accordance with the present invention.

### DETAILED DESCRIPTION OF THE PREFERRED EMBODIMENTS

To make it easy for our examiner to understand the technical characteristics, advantages, and effects of the present invention, a detailed description of preferred embodiments together with related drawings are provided as follows.

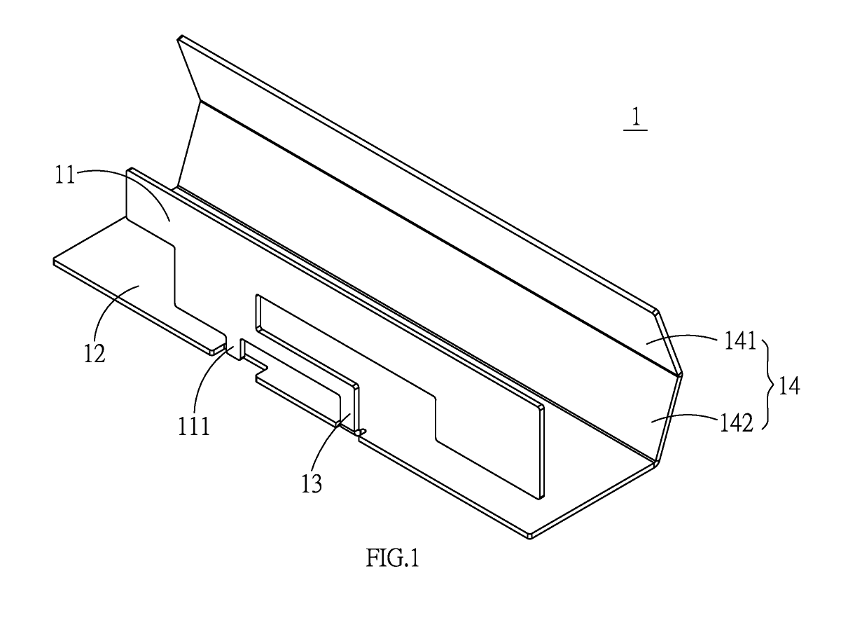

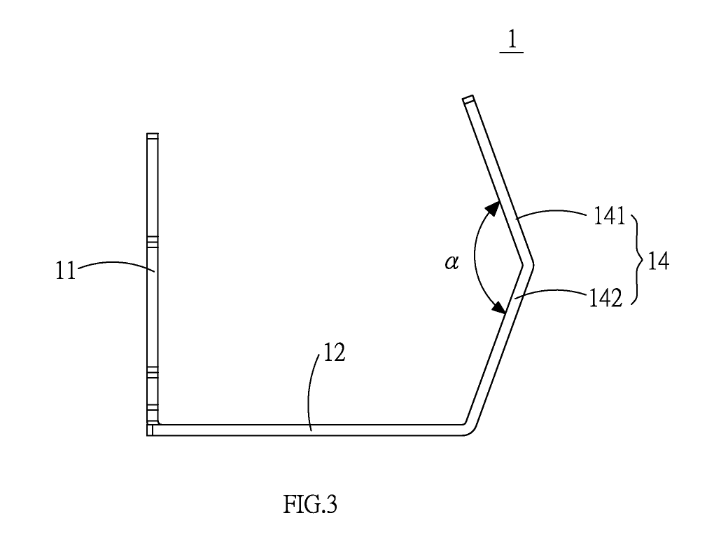

With reference to FIGS. 1 to 3 for an improved structure of an antenna 1 in accordance with the present invention, the antenna structure comprises:

an antenna radiating portion 11, including a feed point 111 for connecting a designated cable 2 of the antenna:

a grounding portion 12, being perpendicular to the antenna radiating portion 11;

a connecting portion 13, formed between the antenna radiating portion 11 and the grounding portion 12, and provided for coupling the antenna radiating portion 11 and the grounding portion 12; and

a reflecting element 14, installed on another side of the grounding portion 12 and corresponding to the antenna radiating portion 11, and including first and second reflecting portions 141, 142.

The antenna radiating portion 11 and the reflecting element 14 of the antenna 1 are integrally formed by bending a metal sheet, and a fixed interval is maintained between the reflecting element 14 and the antenna radiating portion 11 by the grounding portion 12, and the antenna radiating portion 11 is provide for reflecting electromagnetic waves emitted by the antenna through the first and second reflecting portions 141, 142 and guides the electromagnetic waves to travel in a fixed direction, so as to achieve the effects of enhancing the directivity and gain of the antenna, reducing interferences caused by any other external factors, providing a desired directivity, lowering the production cost, and reducing the manufacturing time.

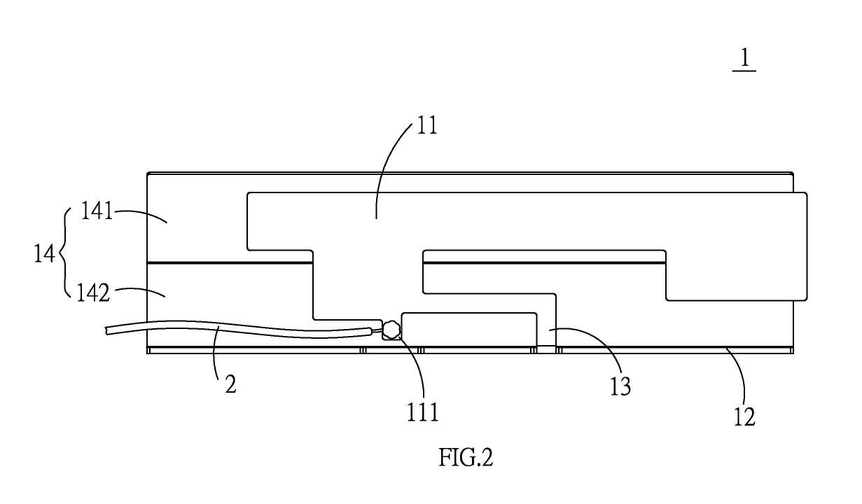

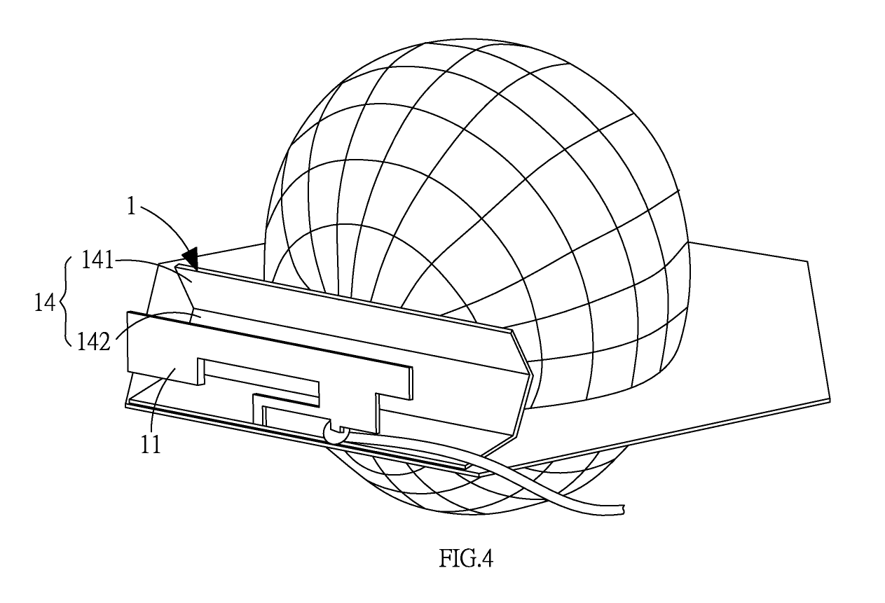

The included angle between the first and second reflecting portions 141, 142 is provided for adjusting and controlling the antenna to obtain a good radiation pattern. In FIGS. 4 and 2, the included angle (α) between the first and second reflecting portions 141, 142 in accordance with the present invention falls within a range of 0˜65 degrees, and preferably in a range of 45˜50 degrees. The radiation pattern of the antenna 1 is substantially in a circular shape, showing a wide coverage and a high radiation efficiency. The antenna 1 of the present invention has good radiation pattern and radiation efficiency.

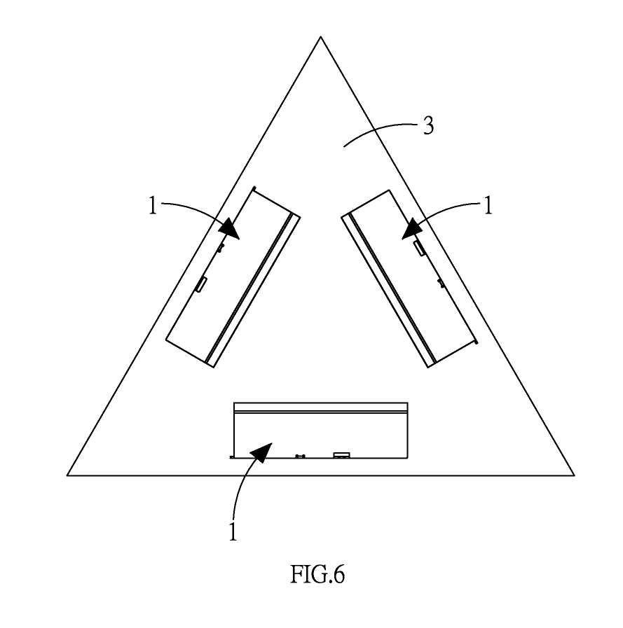

Of course, the present invention can further comprise a base board for installing a plurality of antennas applied in the multi-input multi-output (MIMO) technology. In FIG. 6, the base board 3 includes three antenna devices 1 installed thereon, and the antenna devices 1 are arranged into a triangle, and an included angle of any adjacent two antenna devices 1 is equal to 60 degrees to achieve an omni-directional radiation effect, improve the receiving effect of the antenna, and allow users to make positional adjustments to each antenna device.

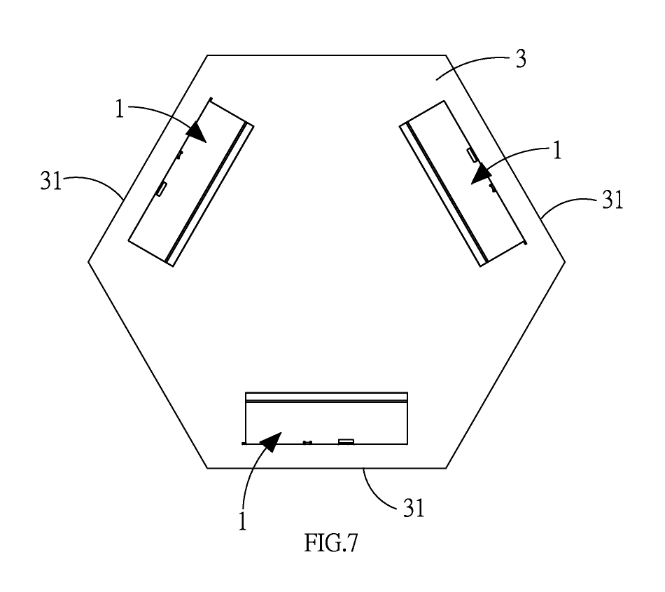

Of course, the present invention can further comprise a base board 3 which is a regular hexagonal board as shown in FIG. 7, and each antenna 1 is installed on three sides 31 of the regular hexagonal board and non-adjacent to each other, and the included angle between any two adjacent antennas 1 is equal to 60 degrees to achieve the omni-directional radiation effect similarly.

In summation of the description above, the present invention provides an improved feasible antenna structure and complies with patent application requirements, and thus is duly filed for patent application. While the invention has been described by means of specific embodiments, numerous modifications and variations could be made thereto by those ordinarily skilled in the art without departing from the scope and spirit of the invention set forth in the claims

What is claimed is:

1. An improved antenna structure, having an antenna device integrally formed by bending a metal sheet, and comprising:
an antenna radiating portion, having a feed point;
a grounding portion, being perpendicular to the antenna radiating portion;
a connecting portion, formed between the antenna radiating portion and the grounding portion, and provided for connecting the antenna radiating portion and the grounding portion;
a reflecting element, installed on another side of the grounding portion and corresponding to the antenna radiating portion, and the reflecting element including first and second reflecting portions, and an included angle between the first and second reflecting portions falling within a range of 0˜65 degrees.

2. The improved antenna structure of claim 1, further comprising a base board for installing a plurality of antennas.

3. The improved antenna structure of claim 2, wherein the base board includes three antennas installed thereon and arranged into a triangle, and an included angle between any two adjacent antennas is equal to 60 degrees.

4. The improved antenna structure of claim 2, wherein the base board includes three antennas installed thereon, and the base board is a regular hexagonal board, and the three antennas are installed of three sides of the regular hexagonal board and non-adjacent to each other.

5. The improved antenna structure of claim 4, wherein the included angle between any two adjacent antennas is equal to 60 degrees.

6. The improved antenna structure of claim 1, wherein the included angle between the first and second reflecting portions is preferably equal to 45˜50 degrees.
